(19) United States
(12) Patent Application Publication
(10) Pub. No.: US 2009/0036112 A1
(43) Pub. Date: Feb. 5, 2009

(54) CELLULAR TELEPHONE WITH A MAGNIFICATION DEVICE AND AN ILLUMINATION DEVICE

(76) Inventor: James Dean Stathis, Towaco, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/830,099

(22) Filed: Jul. 30, 2007

(51) Int. Cl. H04Q 7/20

(52) U.S. Cl. 455/422.1

(57) ABSTRACT

A cellular telephone with a magnification device, illumination device, and operating system implementing basic functions is disclosed.

### FIELD OF THE INVENTION

The present invention relates generally to cellular telephones and more specifically to an improved cellular telephone with a magnification device and an illumination device.

### BACKGROUND OF THE INVENTION

Cellular telephones increasingly have become a necessity in society. Some users may rely upon a cellular telephone to provide more functions than that of a basic telephone. In general, cellular telephones may offer users a variety of functions such as accessing the internet, creating video streams, sending video streams, receiving video streams, creating text messages, sending text messages, receiving text messages, capturing pictures, sending pictures, receiving pictures, gaming, calculating, scheduling, sending telephone calls, receiving telephone calls, and/or other functions associated with a cellular telephone. As cellular telephone technology continues to evolve, the type of functions offered to cellular telephone users may become more and more complex.

Despite this recent evolution in cellular telephone technology, many users may prefer a cellular telephone that provides a limited number of basic functions. For this reason, the cellular telephone industry may continue to offer cellular telephones directed to meeting the basic needs of these cellular telephone users. In addition, many cellular telephone users may desire to combine multiple devices that provide varying functions into a single device for convenience purposes.

### SUMMARY OF THE INVENTION

Accordingly, at least one exemplary embodiment is directed to a cellular telephone device. This embodiment may include an upper portion, upper portion may include one or more magnifiers internal to the upper portion, and a lower portion, the lower portion may include at least a display, wherein the upper portion is hinged to the lower portion.

Another embodiment may provide a cellular telephone device. This embodiment may include an upper portion, the upper portion may include one or more magnifiers internal to the upper portion, and one or more illuminators, and a lower portion, the lower portion may include at least a display, wherein the upper portion is hinged to the lower portion.

An additional embodiment may provide a cellular telephone device. This embodiment may include a single piece, the single piece may include at least one or more magnifiers internal to the single piece, one or more illuminators, a display, and a keyboard, wherein the keyboard comprises one or more symbols.

These and other embodiments and advantages of the present inventions will become apparent from the following detailed description, taken in conjunction with the accompanying drawings, illustrating by way of example the principles of the inventions.

### BRIEF DESCRIPTION OF THE DRAWINGS

FIG. 1 illustrates a perspective view of a cellular telephone with a magnification device and an illumination device according to at least one embodiment of the invention;

FIG. 2 illustrates a perspective view of a cellular telephone with a magnification device and an illumination device in a closed position according to at least one embodiment of the invention;

FIG. 3 illustrates a perspective view of a side of a cellular telephone with a magnification device and an illumination device in an open position according to at least one embodiment of the invention;

FIG. 4 is an exemplary illustration of a top of a cellular telephone with a magnification device and an illumination device while magnifying an object of interest in an open position according to at least one embodiment of the invention;

FIG. 5 is an exemplary flowchart illustrating the method of operation of one or more illuminators associated with a cellular telephone with a magnification device and an illumination device according to at least one embodiment of the invention; and

FIG. 6 is an exemplary block diagram illustrating one or more functions performed by an operating system associated with a cellular telephone with a magnification device and an illumination device according to at least one embodiment of the invention.

### DETAILED DESCRIPTION

The following description is intended to convey a thorough understanding of the embodiments described by providing a number of specific embodiments and details involving a cellular telephone with a magnification device and an illumination device. It should be appreciated, however, that the embodiments of the present inventions are not limited to these specific embodiments and details, which are exemplary only. It is further understood that one possessing ordinary skill in the art, in light of known devices, would appreciate the use of the various embodiments for their intended purposes and benefits in any number of alternative embodiments, depending upon specific design applications and/or other needs or preferences.

A cellular telephone with a magnification device, an illumination device, and/or an OS that implements basic functions may be used to enlarge and/or illuminate one or more objects by individuals with impaired and/or limited vision. OS may include any software and/or hardware used to implement and/or control one or more functions associated with an electrical device.

These individuals may include those that may be classified as a senior citizen, mentally challenged, vision impaired, vision limited, and/or any other classification associated with a need for vision assistance. In various embodiments, individuals that may not need vision assistance may use a cellular telephone with a magnification device, an illumination device, and/or an OS that implements basic functions for the convenience of such functions being associated with a single device.

For example, a cellular telephone may be used to perform additional functions that traditionally may not be performed by a cellular telephone. These functions may include providing a cellular telephone user with a magnification device and/or an illumination device.

According to various exemplary embodiments, a magnification device may include one or more magnifiers. A magnifier may be associated with a lens made of a glass-type material, plastic-type material, polymer-type material, and/or any other material that may be used to enlarge the apparent size of one or more objects of interest. For example, a lens may include a concave shape lens, a biconvex shape lens, a plano-convex shape lens, a convex-concave shape lens, a meniscus shape lens, a plano-concave shape lens, a biconcave shape lens, a fresnel shape lens, and/or any other lens shape that may be used to magnify an object of interest. The preferred embodiment may include one or more magnifiers associated with one or more concave lenses.

An object of interest may include any object a user of a cellular telephone may be viewing. In various embodiments, one or more magnifiers may be configured to be internal to a cellular telephone such that the magnifier portion of the cellular telephone may lay flush with one or more objects of interest. One or more magnifiers being configured to be internal to a cellular telephone may include the one or more magnifiers being fully integrated into an upper portion and/or lower portion of a cellular telephone.

According to various exemplary embodiments, an illumination device may include one or more illuminators. An illuminator may be associated with one or more light-emitting diodes (“LED”) and/or any other light source that may be used to illuminate one or more objects of interest. In various embodiments, one or more illuminators may be configured to be internal to a cellular telephone such that the illuminator portion of the cellular telephone may lay flush with one or more objects of interest. In addition, one or more illuminators may also be positioned within the same plane as one or more magnifiers.

A cellular telephone may include an operating system (“OS”) configured to implement basic functions. In various embodiments, these basic functions may include sending and/or receiving telephone calls, adding, deleting, editing, and/or accessing contacts associated with a contacts list, programming and/or using speed dial, turning on and/or off one or more illuminators, and/or any other basic function associated with a cellular telephone OS.

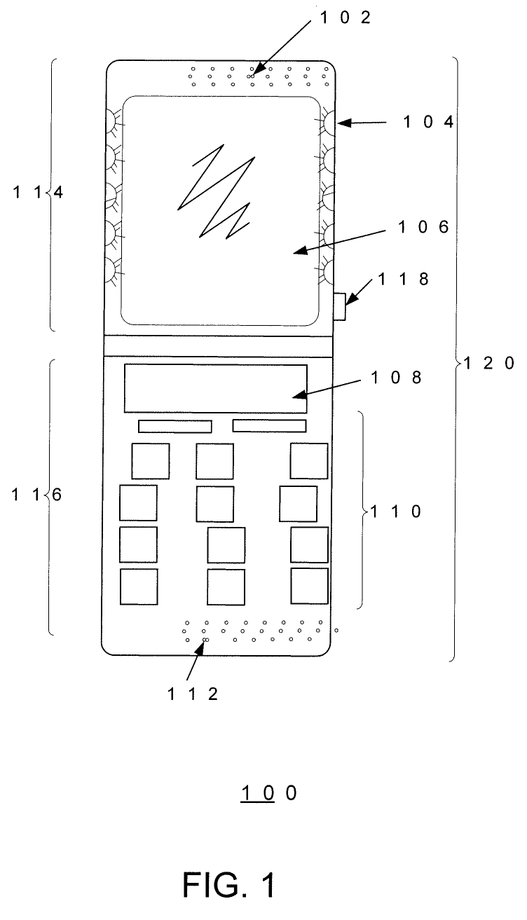

Referring now to FIG. 1, a perspective view of a cellular telephone with a magnification device and an illumination device 100 according to at least one embodiment of the invention is illustrated. Cellular telephone 120 may include upper portion 114 and/or lower portion 116. Upper portion 114 may be hinged to lower portion 116 such that upper portion 114 and lower portion 116 may open to a 180° angle such that cellular telephone 120 may lay flush with one or more objects of interest. In various embodiments, upper portion 114 and lower portion 116 may open to one or more angles less than a 180° angle in addition to a 180° angle. For example, upper portion 114 and lower portion 116 may open to a 160° angle in addition to a 180° angle. While upper portion 114 and lower portion 116 may be illustrated as extending lengthwise along a vertical axis, other configurations may be realized. For example, upper portion 114 and lower portion 116 may also extend lengthwise along a horizontal axis.

Upper portion 114 of cellular telephone 120 may include magnifier 106, speaker 102, illuminator 104, and/or on/off button for one or more illuminators 118. It should be noted that the term magnifier may refer to one or more magnifiers. It should also be noted that the term illuminator may refer to one or more illuminators.

In various embodiments, upper portion 114 may include magnifier 106 that may be internal to upper portion 114. Magnifier 106 may include a lens made of a glass-type material, plastic-type material, polymer-type material, and/or any other material that may be used to enlarge the apparent size of one or more objects of interest. As illustrated in FIG. 1, magnifier 106 may include a transparent material. In another embodiment, magnifier 106 may include a translucent material. In yet another embodiment, magnifier 106 may include a colored material.

As illustrated in FIG. 1, magnifier 106 may be rectangular in shape. In addition, the length and/or width of magnifier 106 may extend closer to and/or farther away from the boundary of upper portion 114 according to design preferences. While magnifier 106 may be illustrated as having a rectangular shape, other shapes and/or configurations may be realized according to design preferences.

Magnifier 106 may provide magnification at one or more magnification strengths. For example, magnifier 106 may provide increasing magnification strength as the distance between magnifier 106 and an object of interest increases. Magnifier 106 may also provide decreasing magnification strength as the distance between magnifier 106 and an object of interest decreases.

According to various exemplary embodiments (not shown), magnifier 106 in upper portion 114 having one magnification strength may be replaced by magnifier 106 having a different magnification strength by a user of cellular telephone 120. For example, a user of cellular telephone 120 may replace magnifier 106 having a magnification strength of 1.25 with magnifier 106 having a magnification strength of 2.50 to meet the vision preferences of the user.

Speaker 102 may include any hardware and/or software used by those of ordinary skill in the art to amplify one or more electrical signals in a form recognizable by a human ear. In various embodiments, speaker 102 may include any electrical device known to those of ordinary skill in the art used to substantially increase amplification for the hearing impaired.

In various embodiments, upper portion 114 may include illuminator 104 that may be internal to upper portion 114. Illuminator 104 may include one or more LEDs and/or any other light source that may be used to illuminate an object of interest. Illuminator 104 may also include one or more LEDs of varying colors, for example, red, blue, white, yellow, green, orange, indigo, violet, and/or any other color associated with a LED.

Illuminator 104 may be configured to be internal to upper portion 114 of cellular telephone 120 such that upper portion 114 may lay flush with one or more objects of interest. In addition, illuminator 104 may also be positioned within the same plane as magnifier 106. Illuminator 104 may also be positioned to surround magnifier 106. For example, illuminator 104 may be positioned to illuminate towards magnifier 106 and/or away from magnifier 106 (e.g., toward an object of interest).

According to various exemplary embodiments, illuminator 104 may be connected to a power source such that one or more electrical signals may be used to turn illuminator 104 on and/or off. Illuminator 104 may be configured to turn on when upper portion 114 and lower portion 116 are in an open position. In addition, illuminator 104 may be associated with timing circuitry. For example, a timing circuit may include a digital counter that may count from zero to a predetermined amount of time. Illuminator 104 may automatically turn off if upper portion 114 and lower portion 116 remain open past a predetermined amount of time. Turning off illuminator 104 if a predetermined amount of time has passed may include ending a flow of electrical signals from a power source to illuminator 104. A predetermined amount of time may be established by the implementers of cellular telephone 120.

In addition, illuminator 104 may be configured to turn on (e.g., illuminate) when on/off button 118 has been turned to an on position. Furthermore, illuminator 104 may be configured to turn off (e.g., stop illuminating) when on/off button 118 has been turned to an off position. By way of a non-limiting example, if the implementers of cellular telephone 120 established a predetermined amount of time of 30 seconds, illuminator 104 may turn off if upper portion 114 and lower portion 116 remain open past 30 seconds. Illuminator 104 may turn on if, for example, a cellular telephone user turns on/off button 118 to an on position. In various embodiments, a timer may be initialized when illuminator 104 is turned on using on/off button 118. In yet another embodiment, a timer may not be initialized when illuminator 104 is turned on using on/off button 118. In various embodiments, illuminator 104 may be turned off by turning on/off button 118 to an off position.

Lower portion 116 of cellular telephone 120 may include microphone 112, keyboard 110, and/or display 108. Keyboard 110 may include one or more keys with one or more enlarged symbols. For example, a key associated with keyboard 110 may have an enlarged number one (e.g., 1). An enlarged symbol may include a symbol that has been printed using the majority of surface area of a key. In one embodiment, keyboard 110 may include one or more enlarged symbols for ease of sight. In another embodiment, keyboard 110 may include one or more standard size symbols (i.e., without enlarged symbols).

Microphone 112 may include any hardware and/or software (e.g., transducer and/or sensor) used by those of ordinary skill in the art to convert sound into one or more electrical signals. Display 108 may include any digital display used by those of ordinary skill in the art to digitally display one or more symbols.

In various embodiments, one or more components associated with upper portion 114 may be associated with lower portion 116. Furthermore, one or more components associated with lower portion 116 may be associated with upper portion 114.

In one embodiment (not shown), cellular telephone 120 may include a single piece device. For example, a single piece device may include one or more magnifiers 106 that may be configured to be internal to the single piece device. In addition, a single piece device may include one or more illuminators 104, a display 108, and/or a keyboard 110. In various embodiments, illuminator 104 may illuminate toward a magnifier 106 and away from a magnifier 106 (e.g., toward an object of interest). A single piece device may include a cellular telephone whereby the portions (i.e., a region associated with a magnifier and a region associated with a keyboard) may reside at opposite ends of each other.

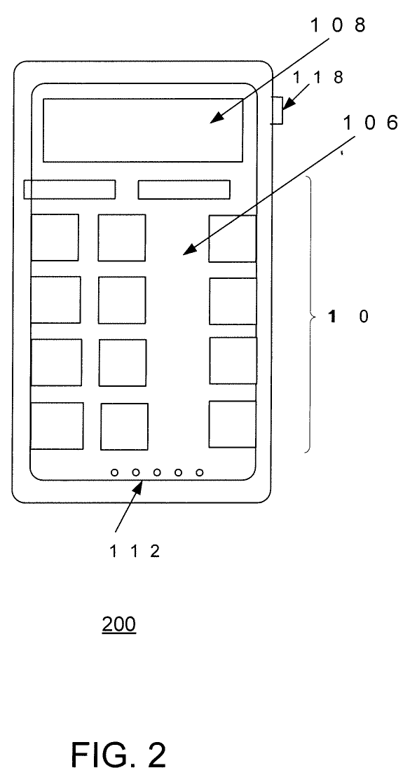

Referring now to FIG. 2, a perspective view of a cellular telephone with a magnification device and an illumination device in a closed position 200 according to at least one embodiment of the invention is illustrated. As previously discussed, a cellular telephone may include magnifier 106, keyboard 110, microphone 112, on/off button 118, and/or display 108. Since magnifier 106 may extend to encompass a large majority of the upper portion of the cellular telephone, when the upper portion and lower portion of the cellular telephone are in a closed position, magnifier 106 may be used as a “window” to view the lower portion of the cellular telephone. As shown, keyboard 110, microphone 112, display 108, and/or any additional components that may be associated with the lower portion of the cellular telephone may be viewed using magnifier 106 as such a “window.” In one embodiment, magnifier 106 may be configured to magnify display 108 when the upper portion and lower portion of the cellular telephone are in a closed position.

If, for example, magnifier 106 is associated with a translucent and/or colored material, one or more components associated with the lower portion of the cellular telephone may be viewed in light of the affect of the coloration of the material. In addition, on/off button 118 may be turned to an on position resulting in an illumination of the lower portion of the cellular telephone using one or more illuminators. If, for example, one or more illuminators are associated with one or more colored LEDs, the illumination of the lower portion of the cellular telephone may also be viewed in light of the effect of the one or more colored LEDs.

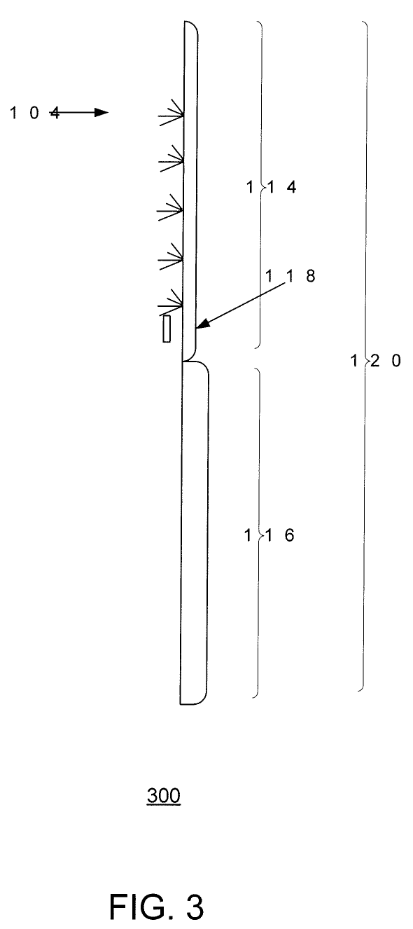

Referring now to FIG. 3, where a perspective view of a side of a cellular telephone with a magnification device and an illumination device in an open position 300 according to at least one embodiment of the invention is illustrated. As previously discussed, cellular telephone 120 may include upper portion 114 and lower portion 116. Upper portion 114 may include illuminator 104 and/or on/off button 118.

As shown, upper portion 114 may be hinged to lower portion 116 such that upper portion 114 and lower portion 116 may open to a 180° angle. Any hinging mechanism that may allow upper portion 114 and lower portion 116 to open to a 180° angle may be used to hinge upper portion 114 to lower portion 116. While in an open position, cellular telephone 120 may lay flush with an object of interest to be used as a magnification device and/or illumination device.

Illuminator 104 may be turned on (e.g., to illuminate) when upper portion 114 and lower portion 116 are in an open position. In various embodiments, illuminator 104 may illuminate toward a magnifier and away from a magnifier (e.g., toward an object of interest). Illuminator 104 may also be turned on using on/off button 118. For example, if illuminator 104 turns off because a predetermined amount of time has passed, a user of cellular telephone 120 may turn on illuminator 104 using on/off button 118.

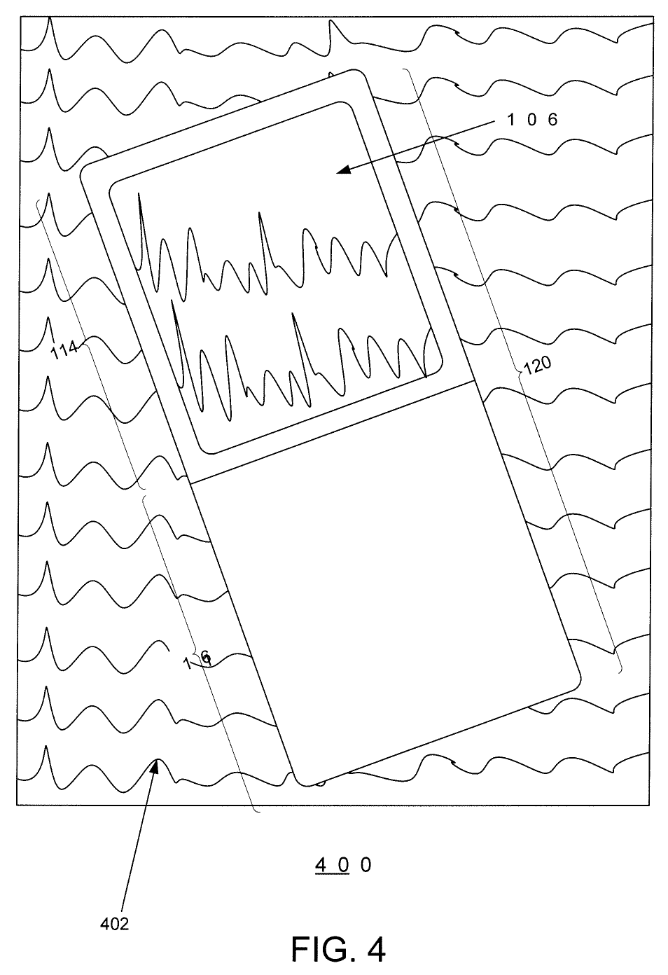

Referring now to FIG. 4, where an exemplary depiction of a top view of a cellular telephone with a magnification device and an illumination device while magnifying an object of interest in an open position 400 according to at least one embodiment of the invention is illustrated. As illustrated in FIG. 4, cellular telephone 120 may include upper portion 114 and lower portion 116. Upper portion 114 may include magnifier 106.

As shown, cellular telephone 120 may be used as a magnification device by laying cellular telephone 120 flush against object of interest 402 (e.g., paper with writing) and increasing and/or decreasing the distance between cellular telephone 120 and object of interest 402 according to the vision preferences of a user of cellular telephone 120. For example, a user of cellular telephone 120 may increase the magnification of object of interest 402 by increasing the distance between cellular telephone 120 and object of interest 402. A user of cellular telephone 120 may also decrease the magnification of object of interest 402 by decreasing the distance between cellular telephone 120 and object of interest 402.

Illuminator (not shown) may illuminate object of interest 402 and magnifier 106 by illuminating toward magnifier 106 and object of interest 402. It should be noted that this depiction is an example of how the various embodiments may be used.

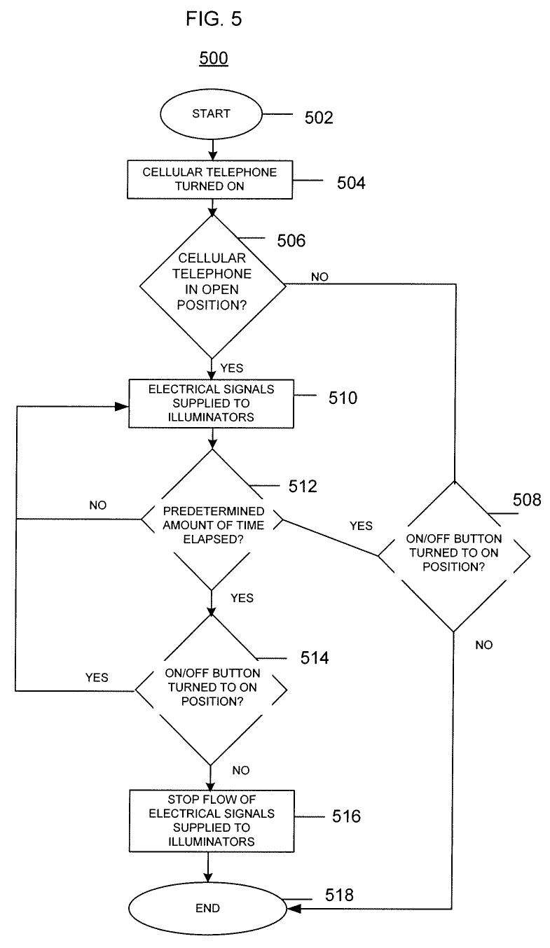

Referring now to FIG. 5, where an exemplary flowchart depicting the method of operation of one or more illuminators associated with a cellular telephone with a magnification device and an illumination device 500 according to at least on embodiment of the invention is illustrated. The method may be initiated in block 502. In block 504, a cellular telephone may be turned on. In block 506 a determination of whether a cellular telephone is in an open position may be made. In block 506, if it is determined that a cellular telephone is in the open position, the method may continue to block 510 and supply one or more electrical signals from a power source to one or more illuminators (e.g., turn one or more illuminators on). A cellular telephone may be determined to be in an open position using software and/or hardware (e.g., sensors) known to those of ordinary skill in the art.

If it is determined that a cellular telephone is not in an open position in block 506, the method may proceed to block 508. In block 508 a determination of whether an on/off button for one or more illuminators has been turned to an on position. In block 508, if it is determined that the on/off button for one or more illuminators has been turned to the on position, the method may proceed to block 510 and supply one or more electrical signals from the power source to one or more illuminators. If in block 508, however, it is determined that the on/off button for the one or more illuminators has not been turned to the on position, the method may proceed to block 518 and end. When one or more electrical signals have been supplied from the power source to one or more illuminators in block 510, it may be determined whether a predetermined amount of time has elapsed in block 512. If, for example, a predetermined amount of time has elapsed, the method may proceed to block 514. If in block 512, however, it has been determined that a predetermined amount of time has not elapsed, one or more electrical signals may continue to be supplied from the power source to one or more illuminators in block 510.

In block 514, a determination of whether the on/off button for the one or more illuminators has been turned to the on position may be made. If, for example, it is determined that the on/off button for the one or more illuminators has been turned to the on position, one or more electrical signals may continue to be supplied from the power source to one or more illuminators in block 510. If in block 514, however, it is determined that the on/of button for the one or more illuminators has been turned to the off position, the method may proceed to block 516.

In block 516, one or more electrical signals may not be supplied from the power source to one or more illuminators. The method may end in block 518.

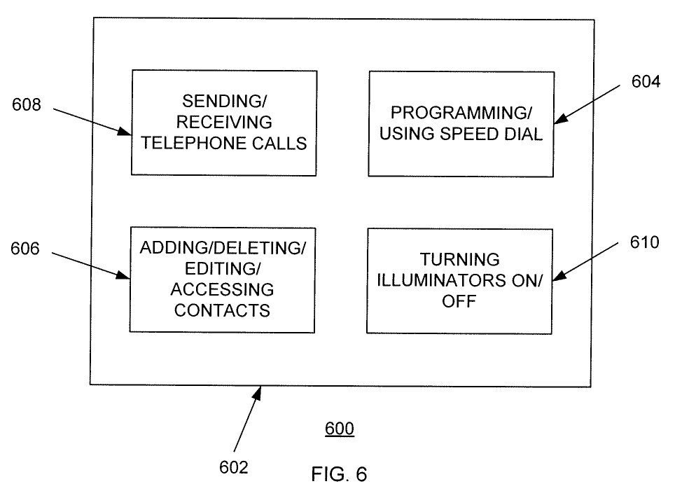

Referring now to FIG. 6, where an exemplary block diagram depicting one or more functions performed by an OS associated with a cellular telephone with a magnification device and an illumination device 600 according to at least one embodiment of the invention is illustrated. A cellular telephone with a magnification device may include an OS 602 configured to implement one or more basic functions. Basic functions may include sending and/or receiving telephone calls 608, adding, deleting, editing, and/or accessing a contacts list 606, programming and/or using speed dial 604, turning on and/or off one or more illuminators 610, and/or any other basic functions that may be associated with a cellular telephone's OS.

OS may include any software and/or hardware used to implement and/or control one or more functions associated with an electrical device.

In various embodiments, a cellular telephone with a magnification device, illumination device, and/or basic OS may be used for individuals with impaired vision, such as, senior citizens, individuals with a need for devices with simple functions, such as, mentally handicapped, and/or for individuals that desire the convenience of such devices being combined into a single device. Other applications and uses may be realized.

While the foregoing description includes many details and specificities, it is to be understood that these have been included for purposes of explanation only, and are not to be interpreted as limitations of the present inventions. Many modifications to the embodiments described above can be made without departing from the spirit and scope of the inventions.

The embodiments of the present inventions are not to be limited in scope by the specific embodiments described herein. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. A cellular telephone device comprising:
an upper portion, the upper portion comprising one or more magnifiers internal to the upper portion; and
a lower portion, the lower portion comprising at least a display;
wherein the upper portion is hinged to the lower portion.

2. The device according to claim 1, wherein the one or more magnifiers comprise one or more magnification strengths.

3. The device according to claim 1, wherein the upper portion further comprises one or more illuminators.

4. The device according to claim 3, wherein the one or more illuminators are internal to the upper portion.

5. The device according to claim 3, wherein the one or more illuminators are configured to illuminate toward the one or more magnifiers.

6. The device according to claim 3, wherein the one or more illuminators are configured to illuminate away from the one or more magnifiers.

7. The device according to claim 3, wherein the one or more illuminators illuminate when the upper portion and the lower portion are open.

8. The device according to claim 1, wherein the upper portion and the lower portion are hinged together such that the upper portion and the lower portion can open to a 180° angle.

9. The device according to claim 1, wherein the lower portion further comprises a keyboard.

10. The device according to claim 9, wherein the keyboard comprises one or more enlarged symbols.

11. A cellular telephone device comprising:
an upper portion, the upper portion comprising one or more magnifiers internal to the upper portion and one or more illuminators; and
a lower portion, the lower portion comprising at least a display;
wherein the upper portion is hinged to the lower portion.

12. The device according to claim 11, wherein the one or more magnifiers comprise one or more magnification strengths.

13. The device according to claim 11, wherein the one or more illuminators are internal to the upper portion.

14. The device according to claim 11, having a plurality of illuminators, wherein at least one illuminator is configured to illuminate toward the one or more magnifiers and at least one illuminator is configured to illuminate away from the one or more magnifiers.

15. The device according to claim 11, wherein the one or more illuminators illuminate when the upper portion and the lower portion are open.

16. The device according to claim 11, wherein the upper portion and the lower portion are hinged together such that the upper portion and the lower portion can open to a 180° angle.

17. The device according to claim 11, wherein the lower portion further comprises a keyboard.

18. The device according to claim 17, wherein the keyboard comprises one or more enlarged symbols.

19. A cellular telephone device comprising:
a single piece, the single piece comprising at least one or more magnifiers internal to the single piece, one or more illuminators, a display, and a keyboard; and
wherein the keyboard comprises one or more symbols.

20. The device according to claim 19, having a plurality of illuminators, wherein at least one illuminator is configured to illuminate toward the one or more magnifiers and at least one illuminator is configured to illuminate away from the one or more magnifiers.
